(19) United States
(12) Patent Application Publication
(10) Pub. No.: US 2003/0115991 A1
(43) Pub. Date: Jun. 26, 2003

(54) Torque transfer mechanism for socket wrench

(76) Inventor: Chin-Chen Huang, Taichung (TW)

Correspondence Address: RABIN & BERDO, P.C., Suite 500, 1101 14th Street, N.W., Washington, DC, 20005, US

(21) Appl. No.: 10/025,786

(22) Filed: Dec. 26, 2001

(51) Int. Cl. B25B 17/00

(52) U.S. Cl. 81/57.29

(57) ABSTRACT

This invention relates an improvement of the torque transfer mechanism exclusively applied to the socket wrench. General speaking, it is an improvement made on the prior art of the socket wrench now popular and available in the tool market. Inside the shank of the socket wrench, it contains a rotary rod connected with a bevel gear which is further meshed with a ring gears on the wrench head. Without changing the profile of the socket wrench, it forms a torque transfer mechanism with robust structure and easy assembly. It provides stable and practical output of the torque for tightening and loosening the bolt.

### BACKGROUND OF THE INVENTION

This invention relates to an improvement of the torque transfer mechanism exclusively used on the socket wrench. The prior art of the socket wrench constitutes an integrally formed handle, a wrench head and a shank. The wrench head has a vertical housing to receive a torque head. A ratchet and a pair of finger-operated brake drum are outfitted in the housing wall with an adjusting knob located on the top of the torque head, permitting the torque head to carry out the right turn or the left turn as the tightening and loosening operation of a bolt desire. The torque input comes from swing the handle of the socket wrench and the torque output is vertically applied to the bolt. However, when tightening or loosening the blot, the handle of the socket wrench must be placed in perpendicular to the bolt. But in the reciprocated swing, it is very hard for the operator to keep the handle on a level; in order word, the swing usually results in an up and down oscillation. This oscillation produces unstable contact of the torque head with the bolt in the square recess as well as an unstabilized torque output. While the blot does not reach a depth to obtain an adequate holding force, and while the handle returns for the next turning, the bolt will follow the torque head to return simultaneously with no resistance. This is an obvious hardness encountered in the very beginning of bolt tightening operation. In other case, the longer the bolt shank the more difficult to be faced in maintaining the level swinging, verticality and accurate contact with the bolt. This shortfall incites a dislike when the consumers use the prior art of the socket wrench. It is necessary to carry out an improvement on the prior art of the socket wrench and this is the goal the invention strikes for.

### SUMMARY OF THE INVENTION

The object of the invention is to provide an improved the torque transfer mechanism for the prior art of the socket wrench where the shank of the socket wrench contains a torque head inside of hollow body. The front end of the torque head is locked on a ring gear which meshes with a bevel gear to form a torque transfer mechanism. The torque transfer mechanism of the invention is robust, easy to assemble and the torque output is stable to enhance easy tightening operation of the bolt.

The another object of the invention is provide an improved torque transfer mechanism for the part art of the socket wrench even without any modification in its construction. It is easy to fabricate, assemble, operate with minor addition of new parts.

The technical characteristics, features and performance of the invention will be explained in great detail by the aid of embodiments illustrated in the attached drawings.

### BRIEF DESCRIPTION OF THE DRAWINGS

FIG. 1 is schematic diagram showing the complete assembly of the invention.

FIG. 2 is the outlook of the bevel gear member of the torque transfer mechanism of the invention.

FIG. 3 is the disassembled of the bevel gear assembly.

FIG. 4 is the bevel gear assembly housed in the interior of the handle.

FIG. 5 is the outlook of the ring gear member of the torque transfer mechanism of the invention.

FIG. 6 is the combination of the bevel gear and the torque head.

### PART NOMENCLATURE AND NUMBERING

| | | | | | |
|---|---|---|---|---|---|
| 10 | Wrench head | 11 | Shank | 12 | Housing |
| 13 | Ratchet | 14 | Pivot tunnel | 15 | Cavity |
| 20 | Torque head | 21 | Clutch lining | 22 | Adjusting knob |
| 23 | Ball cage | 24 | Retaining ball | 30 | Handle |
| 31 | Rotary shaft | 32 | Cushion groove | 33 | Protrusion |
| 34 | Slot | 40 | Bevel gear | 41 | Shaft hole |
| 42 | Tongue member | 43 | Lock screw | 50 | Ring gear |
| 51 | Shaft hole | 52 | Clutch groove | 53 | C-Clamp |
| 54 | Clamp groove | | | | |

### DETAILED DESCRIPTION OF THE EMBODIMENT

Please refer to the attached drawings, it can be seemed that the torque transfer mechanism for the socket wrench of the intention is improved based on prior art of the socket wrench in which the socket wrench constitutes an integrally formed wrench head 10 and a long extended shank 11. The wrench head 10 has a vertical housing 12 to receive a torque head 20. On the housing wall 12, there install a ratchet 13 and a pair of clutch linings 21 disposed oppositely around the torque head 20. When the adjusting knob 22 on the top of the torque head 20 is turned to the left or to the right, The clutch lining 21 will press the ratchet 13 on the wall to make the torque head 20 to transfer the torque output to the left turning or to the right turning with out the housing 12 so as to tighten or to loosen the bolt. The characteristics of the invention are:

In the shank 11, there is a pivot tunnel 14 passing through the housing 12 of the wrench head 10. At the joint of the housing 12 of the wrench head 10 and the shank 11, a cavity 15 is provided to accommodate the bevel gear 40.

A handle 30 is integrally molded with a rotary shaft 31. An adequate cushion groove 32 is furnished between the front end of the handle 30 and the rotary shaft 31. The front end of the rotary shaft 31 has a protrusion 33 in a smaller diameter with a slot 34 cut on the side of the protrusion 33. As shown in FIG. 3, the rotary shaft 31 is forced to slide into the pivot tunnel 14 in the shank 11 by turning the handle 30, where a part end of the shank 11 will enter the cushion groove 32 in the handle 30 and the protrusion 33 of the rotary shaft 31 will extend into the housing 12 of the wrench head 10 so as to lock the bevel gear 40 in place. As shown in FIG. 4, when the bevel gear 40 is locked in place, pulling back the rotary shaft 31 will retreat the bevel gear 40 into the open of the cavity 15.

The shaft hole 41 of the bevel 40 has a tongue member 42. When the shaft hole 41 of the bevel gear 40 is sleeved onto the protrusion 33 of the rotary shaft, the tongue member 42 intimately contacts the slot 34 on the protrusion 33 to secure both firmly and to produce a synchronized action between the bevel gear 40 and the rotary shaft 31. The bevel gear 40 is tightened on the top of the protrusion 33 by a screw 43.

A ring gear 50 has a go through shaft hole 51 and a clutch groove 52 at the bottom end. Around the wall of torque head 20, there outfits a ball cage 23 to hold the retaining ball 24 in place. Part of retaining ball 24 exposes out of the wall of the torque head 20. When the torque head 20 sleeves into the shaft hole 51 of the ring gear 50, the clutch groove 52 of the ring gear will sit on the exposed part of the retaining ball, so that by means of ball cage 23 and the clutch groove 52, the ring gear 50 and the torque head will act synchronically.

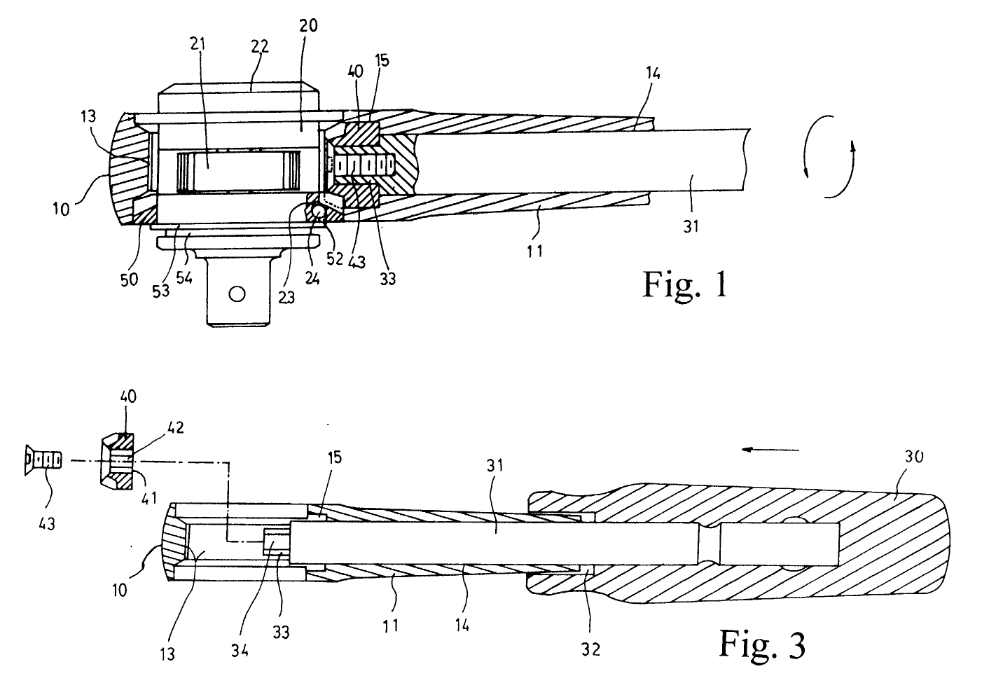

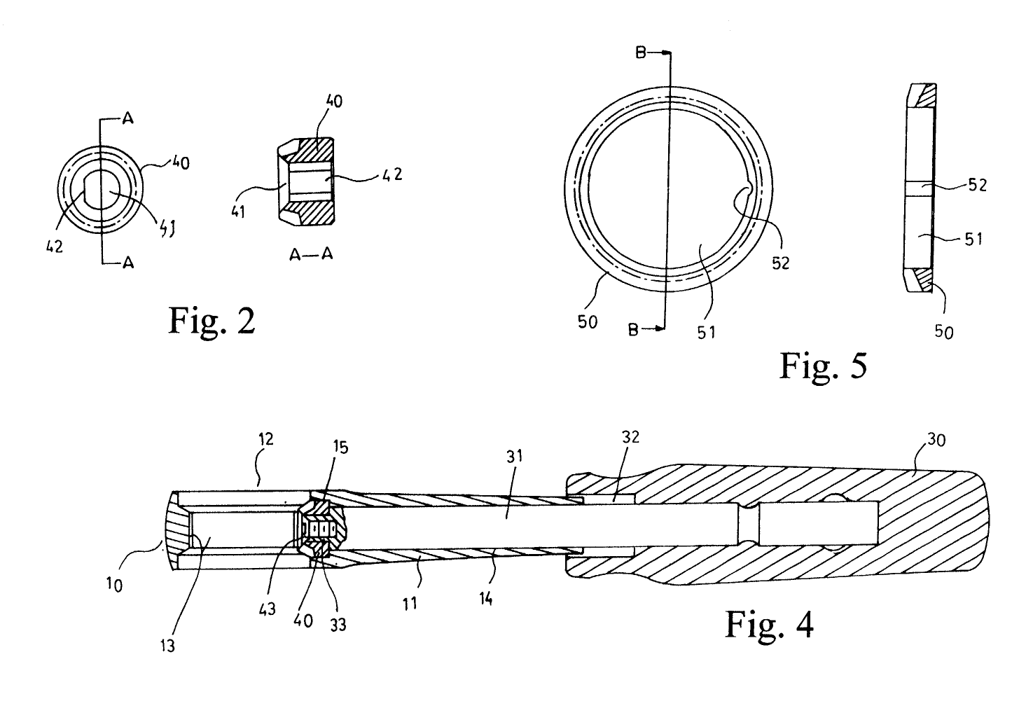

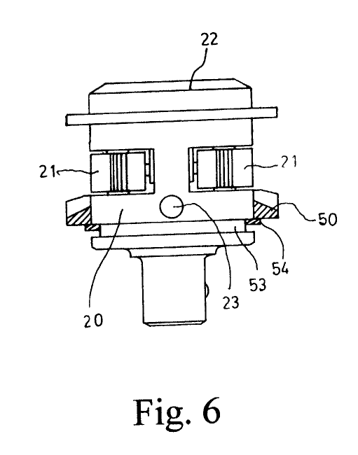

As shown in FIG. 1, the torque head 20 is inserted into the housing 12 of the wrench head 10, and the ring gear 50 is sitting onto the torque head 20 in the housing 12. the torque head 20 is locked by sliding the C-clamp 53 into the clamp groove 54, so the torque head 20 and the ring gear 50 are secured firmly in the housing 12 of the wrench head 10. The ring gear 40 meshes perfectly with the bevel gear 40 which is constantly confined in the open of the cavity 15 of the housing 12.

The practical operation of the socket wrench of the invention is described below:

When the adjusting knob 22 turns the clutch lining 21 to make the torque head 20 to transfer the left torque output, in the prior art of socket wrench, to reciprocate swinging the shank 11 will achieve the torque output. However, the invention does not consider the reciprocating swing of shank is a unique way to transfer the torque output. In the invention, the handle 30 is used a fixed swivel point, by dint of rotary shaft 31, together with the bevel gear 40 the ring gear 50 to rotate the torque head 20 for the torque output. At the moment when the bolt require the maximum torque to tighten, the swing of the socket wrench is put in action. In other word, turn the adjusting knob to set the clutch lining 21 onto the torque and to change the right torque output so as to achieve the purpose.

From the above statement, the invention embraces the practicability and progresses as follows:

1. Without any modification on the fundamental structure of prior art of the socket wrench, the invention provides another embodiment of torque transfer mechanism for easily tightening operation of the bolt.

2. The said another embodiment of torque transfer mechanism is fast to fabricate, easy to assemble with minor addition of production cost for a few new parts.

3. The said another embodiment of torque transfer mechanism employs the bevel gear meshing with the ring gear to achieve a stable and solid torque output.

4. The interior of shank of the handle houses the bevel gear at the front end of rotary shaft make the combination robust and convenient.

Viewing from the above statement, it is understood that the invention has removed the shortfalls the prior art of the socket wrench cherishes, enhanced its efficiency and lifted its application value. It is therefore justified to apply a patent for this invention.

What is claimed is:

1. An improved torque transfer mechanism for the socket wrench constitutes an integrally formed wrench head and a long extended shank, the wrench head has a vertical housing to receive the torque head, the wall of the housing is outfitted with ratchet and pair of clutch linings, when the adjusting knob on the top of the torque head is turned to left or the right, the clutch lining will extend and contact the torque head which further contacts the ratchet on wall to produce a left torque output or a right torque output, characterized in that:
the shank of the handle has a go-though tunnel to the housing of the wrench head, at the joint of housing and the pivot tunnel, there exists a cavity for receiving the bevel gear;
a handle is integrally molded with a rotary shaft, an adequate cushion is provided between the front end of the handle and the rotary shaft, the front end of the rotary shaft has a protrusion, smaller in size compared with the diameter of the rotary shaft, having a slot on the side;
a bevel gear has a tongue member in the inside of shaft hole;
a ring gear has a go-through shaft hole with a clutch groove at the bottom end;
the wall of the torque head contains a ball cage to hold the retaining ball in place with part of the retaining ball exposed outward, when the ring gear slide into the torque head in the wrench head, the clutch groove will sit on the exposed part of the retaining ball to form a synchronized action with the torque head, the ring gear is meshing on the bevel gear which is sleeved on the protrusion of the rotary shaft so as to restrict the bevel gear constantly locked in the cavity of the housing, this is the embodiment of the torque transfer mechanism for the socket wrench.
